(19) United States
(12) Patent Application Publication
(10) Pub. No.: US 2016/0371730 A1
(43) Pub. Date: Dec. 22, 2016

(54) SYSTEM AND METHOD FOR INCENTIVIZING ACTIONS OF USERS OF MOBILE DEVICES

(71) Applicant: Knotis Inc., Seattle, WA (US)

(72) Inventors: Josie M. Imlay, Seattle, WA (US); McLean R. Reiter, Seattle, WA (US)

(73) Assignee: Knotis Inc., Seattle, WA (US)

(21) Appl. No.: 15/187,709

(22) Filed: Jun. 20, 2016

Related U.S. Application Data
(60) Provisional application No. 62/182,315, filed on Jun. 19, 2015.

(51) Int. Cl. G06Q 30/02; H04W 4/02

(52) U.S. Cl. CPC G06Q 30/0255; H04W 4/028; G06Q 30/0261

(57) ABSTRACT

A system and method that allows an entity to request and incentivize the user of the mobile device to perform an action. The incentivizing of the user can be in a non-monetary second utility unit, such as coupon, voucher or credit unit, which can be optimized to give the greatest value to the user and least cost to the requesting entity to cause the incentivized action. The geographical location of the mobile devices of the user is known, and based upon the location, actions at the mobile devices can be requested, such as going to a specific location, the taking of a picture, posting of text, and answering a survey. Once the requested action is performed, a coupon or other second utility unit can be sent to the user of the mobile device or placed in the user account.

### CROSS-REFERENCE TO RELATED APPLICATION

This application claims the benefit of U.S. Provisional Patent Application No. 62/182,315, filed on Jun. 19, 2015, the entirety of which is hereby incorporated herein by this reference.

### BACKGROUND OF THE INVENTION

1. Field of the Invention

The present invention relates to applications that interact with mobile devices across a telecommunication network. More particularly, the present invention relates to a system that allows entities to request users of mobiles device to perform certain actions at the mobile device and incentivize the user with compensation for performing the action.

2. Background of the Invention

Social media is a common form of communication and interaction. Mobile devices have the ability to capture audio and video data and post the data to websites, as well and sending the data to other devices. Users of the mobile device can also input text and have it posted to social media websites. There is generally no limit on the ability of users to post social media and other facts to websites, and as a consequence, the content of social media is not verified as to accuracy or reliability. Consequently, social media is a poor data source for information.

There are existing applications on the Internet that request users of mobile devices to perform certain actions, such as taking and sending a picture, or writing and posting a comment to a social media website, and the user of the mobile device will receive some type of reward for having done so. The users that post the requested media can be compensated for the post such as by automatically being entered in a drawing, receiving a coupon, or receiving some other benefit. These reward applications are typically server-based, accessible by the mobile devices only across the Internet, and are limited in the actions that can be requested of mobile device users and the type of benefit given the users for the action performed. Furthermore, the users of the mobile devices often need to be made aware of the promotion to post social media and it is, therefore, very difficult to get significant participation in these types of promotions.

In extant promotions, the type of benefit conferred to a user of a mobile device to incentivize them to take a particular action is often limited in its potential use. The potential incentive of greatest value to the user is a typically a unit of compensation directly tied to a money value. However, that is the most expensive, and thus least desirable, method for a company to use to try to incentivize the user of the mobile device. Instead of money, the company that wants to incentivize the users to gather data would rather use a form of economic or utility unit that costs the company the least amount of money to implement, such as a discount on the company's good or service, a coupon, a rebate, or some other incentive in a non-direct monetary unit. Yet, the user does not like the limited use of the non-monetary unit, especially as it is typically tied to some other action or limited on how the value can be realized. Because of the divergent interests of the promoting company and mobile device user, the value of the limited use, non-monetary unit needed to adequately incentivize a user can even be greater than the money amount necessary to accomplish the same incentivizing.

### SUMMARY OF THE INVENTION

Briefly described, the present invention is a system and method comprised of one or more servers on the Internet and telecommunication network that communicate with applications installed at mobile devices and allows an entity to use the server to request the user of the mobile device to perform an action and receive an incentive for performing the action. The mobile devices can be smartphones, laptops, etc., of individual users. The incentivizing of the user can be in a non-monetary unit, such as coupon, voucher or credit unit, which can be optimized to give the greatest value to the user and requesting entity to cause the incentivized action. The servers are aware of the geographical locations of the mobile devices of the users. The servers can request actions at the mobile devices, such as going to a specific location, the taking of a picture, posting of text, answering a survey, etc., and once the action is performed, the server can send a coupon or other compensation unit to the mobile device that can be redeemed for a value to the user of the mobile device, or can add second utility units to an account of the user of the mobile device.

In one embodiment, the invention can include applications that are installed at a store or other retail location that allow the redemption of the non-monetary compensation unit of utility such that the user can be compensated for the incentivized action right at the location that the action is occurring. The system can therefore gather social media data reliably and have users of the mobile devices perform a wide variety of actions as they are incentivized by the reward given once the action is complete.

In one embodiment, the invention can include an application on a mobile device that can receive instructions from the servers, instruct the user of the action to perform, receive the required input from the user, and can selectively release or activate the incentive. The application can effect any or all of the incentivizing action, and can even trigger the action based upon the location the mobile device detects that it is at.

In one embodiment, the invention can include system that dynamically determines the amount of compensation utility units needed, either monetary, non-monetary, or both, to incentivize the user for a specific action. The system can gather survey data, historical data, and/or live time question data to optimize the likelihood of the incentivized action occurring with the best perceived result to the user and requesting entity. The system can engage in a real-time negotiation with the user of the mobile device to make the data gathering request transaction have the most optimal benefit to the entity that wants data gathered and the user of the mobile device.

### BRIEF DESCRIPTION OF THE DRAWINGS

FIG. 1 is a perspective view of the system embodied as occurring between a data center and mobile device in communication across a wireless network, such as the internet and cellular network, with the user and mobile device within the geo-fence of a store.

FIG. 2 is a perspective view of the user of the mobile device taking a picture of items in the store as an incentivized action.

FIG. 3 is a flowchart of one embodiment of a process for determining the location of the mobile device, determining if an incentivized action is to be requested of the user, sending the request to the user, and crediting the user for performing the action.

FIG. 4 is a flowchart of one embodiment of a process to calculate the optimal secondary utility unit value to give the user to properly incentivize the user to perform the action.

### DETAILED DESCRIPTION

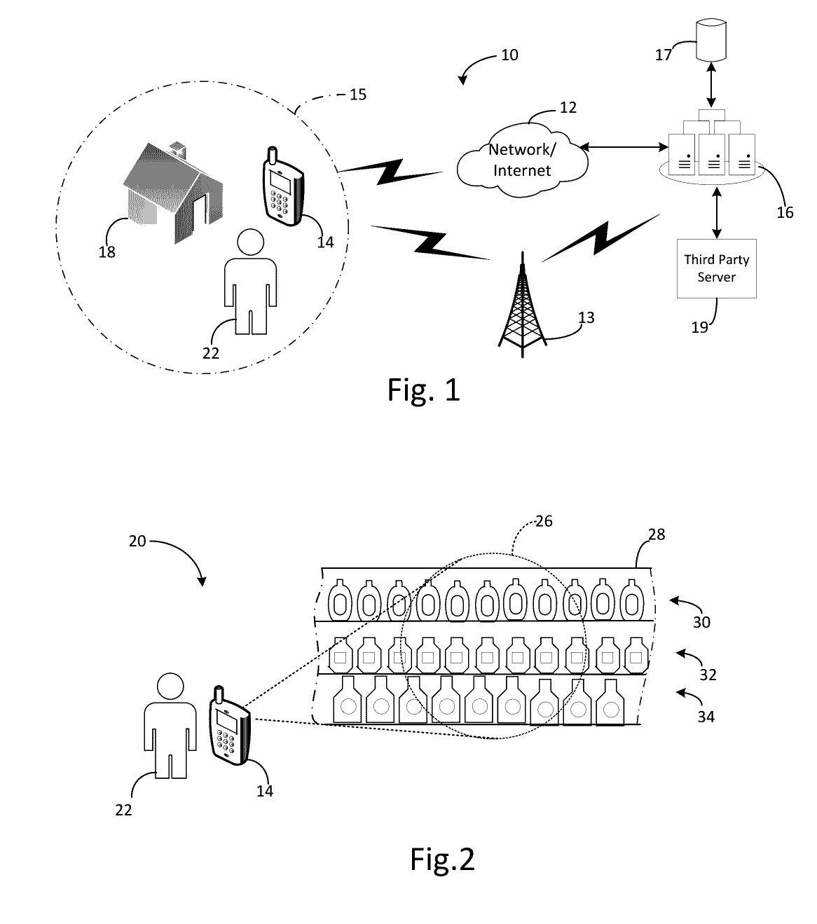

With reference to the drawings, FIG. 1 is a perspective view of the system 10 embodied as occurring between a data center 16 and mobile device 14 in communication across a wireless network, such as the internet 12 and/or cellular network 13, with the user 22 and mobile device 14 within the geo-fence 15 of a store 18. Geo-fences are known in the art and basically are a preset distance surrounding a location such that the data center 16 knows that the user 22 is in proximity to the store 18 and can incentivize the user 22 to perform an action relative to the store 18. The data center 16 can be any combination of computer devices at the same physical location or spread out, and could be entirely cloud-based. The mobile devices can be smartphones, laptops, etc., of individual users, which have resident computer applications that effect the actions as described herein. The applications can also be installed at store 18 or other retail locations that allow the redemption of coupons or other compensation units.

The system uses wireless network 12, such as the Internet, to communicate with a data center 16 that can include one or more servers and networked computer devices as is known in the art. The data center 16, as embodied here, includes a database 17 that stores information on the geo-fenced locations (such as geo-fence 15) and entities that are interested in gathering and maintaining data about the location. For example, the owner of the chain of stores for store 18 may be interested if any user 22 enters the geo-fence of their stores and want to immediately have the user 22 take a picture of themselves at the store. The database 17 also contains second utility units, such as coupons, vouchers, resources, etc., that are potentially applicable to potential transactions, where the second utility units have a different value than a first utility unit for a transaction that can be used within a purchase or other utility transaction. In the example of the store chain, the second utility units can be used by the store chain, perhaps being a virtual coupon that can be used in a purchase transaction at the store, to incentivize the user 22 to take the picture within the store. Once the picture is received at the data center 16, the coupon is then sent to the mobile device 14 of the user 22.

The data center 16 can also include connectivity to a third party server 19, such as a manufacturer, distributer or retailer server that the data center 16 can connect to when a geo-fence or other desired location is entered by a user 22 of the system 10 as further described herein. For example, upon a user 22 entering a geo-fence location, or in one embodiment, requesting to make a purchase at a specific location, such as store 18, which alerts the data center 16 that the user 22 is present within the geo-fence 15, the data center 16 can inform the third party server 19, such as the store chain owner of store 18 that the user 22 is present there. If the database 17 is aware of the preference of the third party with respect to information wanted from user 22 at its location, the data center can send a preset offer to the user 22 with second utility units, such as coupons, to the potential purchase transaction to make the user perform an action. If the database 17 includes an account about the user 22, the database 17 have information on what incentive in second utility units are preferable to send to the is user 22.

In such manner, the data center 16 can use different second utility units to entice a user 22 to perform an action that is has available beyond what the interesting entity is for the data gathering. For example, one store chain that may be interested in getting information from users 22 patronizing their stores may be able to have the data center 16 use coupons from other stores or other second utility unit incentives if the user 22 is not particularly interested in coupons from the store they are at where in the information needs to be gathered.

In one embodiment, the database 17 further stores a plurality of accounts for potential users to such that the data center 16 further allocates secondary utility units to the account of a user as the method of compensation, as opposing to transmitting one or more second utility units at the time of the requested action. For example, the data center 16 can allocate coupon points or other generic second utility units to the account of the user 22 that may have no application within the store 18 at all. This allows a much higher likelihood of incentivizing the user 22 to perform the action rather than a simple in-store coupon. Thus, the system 10 can apply the secondary utility unit to account of the user 22, or can be embodied to apply secondary units within a purchase transaction itself, but not necessarily in a monetary value, e.g., a 2 for 1 coupon or a voucher for a free gift.

The servers at the data center 16 are aware of the geographical locations of the mobile devices 12 of the users, such as store 18, which can occur for the location devices inherent in mobile devices, such as GPS data, tower data, network attachment points, or can occur from other transactions by the mobile device 14 at the location, such as signing into a Wifi network, requesting to make a purchase, or other transaction on the network. The system 10 can request actions at the mobile devices 14, such as going to a specific location, the taking of a picture, posting of text, answering a survey, commenting in social media, etc., and once the action is performed, the server can send a coupon or other compensation unit to the mobile device 14 itself, or to the account of the user 22, that can be redeemed for a utility value to the user 22. The system 10 can therefore gather social media data, marketing data, and other data of value more reliably that other systems as users 22 of the mobile devices 14 are far more likely to accurately perform a wide variety of actions as they are incentivized by the reward given once the action is complete.

In one embodiment, the mobile device 14 itself, through a resident application, can detect its geographic location and determine if it is proximate to a location where an incentivized action is possible. For example, if the mobile device 14 detects that it is in the wifi range of a particular store 18, the mobile device 14 can tell the data center 16 that the user 22 is at that store 18 and the data center 16 can determine if an incentivized action is desired to be asked of the user 22.

As shown in an embodiment in FIG. 2, the system 10 offers a compensation unit to the mobile device user 22 to enter a store 18, the compensation unit being embodied here as an electronic coupon, when the mobile device 14 is within geographic proximity to the store 18, i.e., within the geo-fence 15. The incentivized action here is to have the user 22 enter the store 18 interior 20 with the mobile device 14 to take a picture 26 inside the store 18 of specific retail items, shown here as comparable items 30,32,34 that reside on the same location on the shelf 28, and then have the user 22 send the picture 26 to the data center 16 through an application resident at the mobile device 14. Thus, in this embodiment, the system 10 can gather comparative data for items at a retail location and their price. The system 10 will also know the specific time the picture 26 was taken so the data can be extremely current.

Further, the application resident at the wireless device 14 can also capture other data through the resident sensors at the device 14, such as recording sound via the microphone, taking picture data outside the visible light spectrum, recording temperature and other data, utilizing accelerometers and altimeters, and the like. The range of user actions that can also include data entry by the user 22, such as in FIG. 2, by asking the user 22 if they would buy any of the items 30,32,34 at a specific price, or have the user 22 enter in what price they would purchase the items 30,32,34 at. Once the action is complete, or in this embodiment, that the picture 26 and marketing question data have been received at the data center 16, the coupon or other unit of value is sent to the account of the user 22, or can be sent directly to the mobile device 14 for use at the location where the data was gathered from.

There are several potential uses for the gathered data at the data center 16. For example, the redemption of the coupons allow the users 22 of the mobile devices 14 to verify that a store 18 is using the system 10 to process coupons, or other data on the store 18 can be obtained, such that the store 18 can become verified on the system 10, i.e., the system 10 will know if the store 18 is correctly using the coupon payment system. In a like manner, the verified store 18 can also verify that the user 22 of the mobile device 14 is using the resident application to redeem coupons, and thus the system 10 can know the user 22 is properly using the system 10 to have access to the coupon. Once the users 22 are verified, i.e., the system increases its level of trust that the user is bona fide, verified users of the system 10 can then be more freely allowed to post media to the system 10 to better insure the validity of the uploaded data. The verification system can therefore guard against fraudulent use of the discounts of the system 10 by stores 18 or users 22 in this matter. Furthermore, the system 10 can monitor the periodicity of coupon redemption (or use of the second utility units) by the store 18 and/or user 22 and can determine if there is potentially a technical error in the system 10 or at the wireless device 14 or store 18 if the coupons are not being redeemed within the normal range of time, e.g., no coupon has been redeemed within an hour.

Through the use of the incentivized actions, the system 10 can therefore provide, in one embodiment, an entity to create a social media website and user interface at the mobile device 14 that can guarantee the accuracy and temporality of the social media gathered by its verified users 22. The users 22 can be incentivized via second utility units, such as electronic coupons or other compensation units, to gather data from specific location within a specific period and post it to the website. One example is guaranteeing the time and place that pictures were taken in a location, e.g., a picture taken in a bar within the last 30 minutes. The system 10 can thus incentivize users 22 update the social media on a regular, periodic basis, and the fresh data can tremendous value to other users that can view the website, such as what it happening at various bars that a person is contemplating going to.

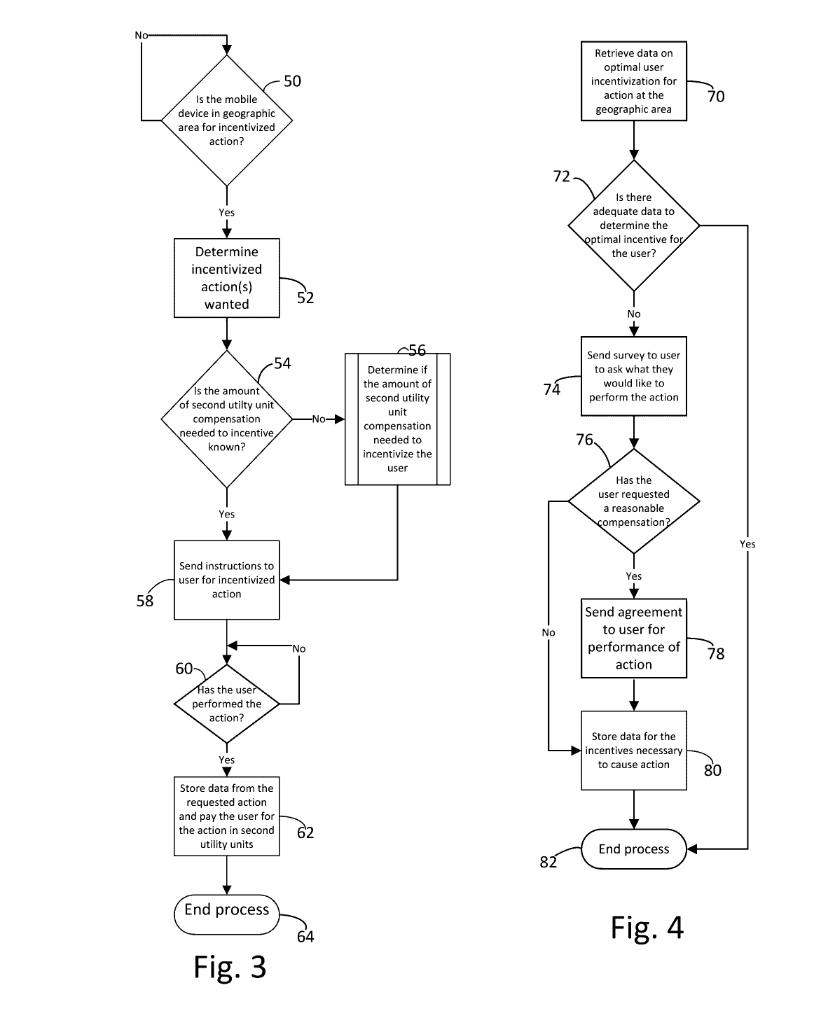

FIG. 3 is a flowchart of one embodiment of a process for determining the location of the mobile device 14, such as within geo-fence 15, and determining if an incentivized action is to be requested of the user 22, sending the request to the user 22 via the mobile device 14 application, and crediting the user 22 for performing the action. The process begins with a determination being made as to whether the mobile device 14 is in a geographic area for an incentivized action, as shown at decision 50. An example of this is the user 22 and mobile device 14 being within the geo-fence 15 of the store 18 in FIG. 1. Alternately, the mobile device 14 can trigger the process if it determines that the data center 16 that the user 22 is at a geographic location of interest. If the mobile device 14 is not within a geographic area where an incentivized action is needed at decision 50, the process iterates thereat to await the mobile device 14 entering a relevant area. Once the mobile device has entered a location where an incentivized action is possible, e.g., has entered a known geo-fence 15, a determination is then make on what incentivized actions, if any, are desired to have the user 22 perform at the geographic location, as shown at step 52.

A determination is then made as to whether the amount of second utility units needed to incentivize the user 22 is known, as shown at decision 54. If the number of units are not known at decision 54, then a subroutine is performed to determine the optimal amount of compensation, or here, number and type of second utility units, is performed as shown at subroutine 56. FIG. 4 is one embodiment of the subroutine of step 56. After subroutine 56 is performed, or if the number of secondary utility units were known at decision 54, then the instructions for the incentivized action is sent to the mobile device 14 for display to the user 22, as shown at step 58. Then a determination is made as to whether the user 22 has performed the incentivized action, as shown at decision 60.

If the incentivized action has not been performed at decision 60, the process iterates thereat until the user 22 performs the task, which would be indicated by the application at the mobile device 14. The wait state at decision 60 can have a preset time-out limit so that the application does not hang. Otherwise, once the user 22 performs the incentivized action at decision 60, the data from the action is stored and the user 22 is credited for the action, such as by sending a coupon to an account of the user 22 or directly to the mobile device 14, as shown at step 62. Then the process terminates as shown termination 64, and then an overall wait state is reentered at decision 50 to determine if the mobile device 14 moves into another known geographical area of interest for a potential incentivized action.

FIG. 4 is a flowchart of one embodiment of a process to calculate the optimal secondary utility unit value to give the user 22 to properly incentivize the user 22 to perform the incentivized action, and is referenced as subroutine 56 in FIG. 3. The process starts be retrieving data on the optimal user incentivization for an action at that specific geographic area, as shown at step 70. This can be retrieving data on past incentivized actions at that location, overall data on the incentives required to cause that specific incentivized action, or other general transaction information relative to the user 22 or more general statistical data. Step 70 can also include retrieving data of what incentive a company is willing to put into the transaction to have the user 22 perform the action. For example, how large of a coupon or discount is the company willing to give to have the user 22 perform a survey or gather other marketing data, or buy a specific product at the store 18.

A determination is then made as to whether there is adequate data to determine the optimal second utility units needed, i.e., economic motivation, to provide sufficient incentive to have the user 22 perform the action, as shown at decision 72. Decision 72 can also include a calculation to insure that incentive is optimal to a company or entity providing the second utility unit as well if the company has an interest in the incentivized action. If there is adequate data at decision 72, then the process sends the data for the action back to the process of incentivizing the user 22 as shown in FIG. 3 and the subroutine process terminates, as shown at termination 82. Otherwise, in this embodiment, if there is not adequate data at decision 72, a survey or other questionnaire or inquiry is sent to the user to ask what incentive the user 22 requires to perform the action, as shown at step 74. The survey itself can include incentives for the user 22 to answer it, such as with a coupon or compensation credit provided upon return of the survey.

Then a determination is made as to whether the user 22 has requested reasonable compensation for the incentivized action, as shown at decision 76. If the user 22 has not requested reasonable compensation for the action, such as asking for a coupon greater than a company will allow, the process forward to step 80 to store the data for the economic incentives necessary to cause the incentivized action by the user 22, and then the subroutine terminates at termination 82. Otherwise, if the user 22 has requested reasonable compensation at decision 76, then an agreement is indicated to the user to perform the incentivized action as shown at step 78 and the data for the transaction is again stored as shown at step 80 and the subroutine terminates as shown at termination 82.

FIG. 4 is simply one embodiment of the subroutine to determine the optimal amount of economic unit compensation for incentivizing the user 22. Several methods can be used in parallel to make the determination, such as a reverse auction among multiple users 22, e.g., the system 10 can ask several users will they perform the incentivized action for a specific coupon discount, and keep asking the users until the lowest compensation amount is reached and then send an agreement to the lowest bidding user 22.

Although preferred embodiments of the invention have been disclosed in the foregoing specification, it is understood by those skilled in the art that many modifications and other embodiments of the invention to which the invention pertains will come to mind, having the benefit of the teaching presented in the foregoing description and associated drawings. Moreover, although specific terms are employed herein, they are used in a generic and descriptive sense only, and not for the purposes of limiting the described invention.

What is claimed is:

1. A system for incentivizing and tracking an action of a user of a remote mobile device, comprising:
at least one server that is selectively accessible to remote mobile devices across a network;
a database, resident on the at least one server, that stores, at least:
a data set of geographic regions for which data is gatherable; and
second utility units that are potentially applicable to potential utility exchange transactions in a first utility unit, the second utility units having a different value than the first utility units that are used in utility exchange transactions;
the server selectively detecting that a mobile device has entered a geographic region;
the server further reviewing the database to determine if data is to be gathered for the geographic region of the mobile device; and
if data is to be gathered, the server sending a request to the mobile device for the user to gather data regarding the geographic region that the mobile device has entered, the request including, at least, second utility units that are to be given to the user of the mobile device if the user gathers the requested data and transmits that data to the server.

2. The system of claim 1, wherein the mobile device sends data to the at least one server regarding an intended purchase transaction in a first utility unit, and the server further determining second utility units to apply within the requested purchase transaction if data is to be gathered for the geographic area of the mobile device.

3. The system of claim 1, wherein user of the mobile device further sends a desired compensation amount in second utility units to the server upon the mobile device receiving a request to gather data on a geographic region.

4. The system of claim 1, wherein the server further sends a plurality of options of second utility units to the user of the mobile device that the user can receive for gathering the requested data, and the server further receiving data from the user indicating a selection of a specific option of second utility units.

5. The system of claim 4, wherein the database further includes a plurality of user accounts for second utility units, and the server further allocating second utility units to the account of the user upon receipt of the requested gathered data.

6. The system of claim 2, wherein, upon receipt of the requested gathered data, the server further applying second utility units within a requested purchase transaction by the user in first utility units.

7. The system of claim 1, wherein the server determines if the mobile device has entered a geographic region based upon location information sent from the mobile device.

8. The system of claim 1, wherein the server determines if the mobile device has entered a geographic region based upon the receipt of a purchase transaction request sent from the mobile device.

9. A system for incentivizing and tracking an action of a user of a remote mobile device, comprising:
a computing means for interacting with a plurality of remote mobile devices across a network;
a database means, resident on the computing means, for storing, at least:
a data set of geographic regions for which data is gatherable; and
second utility units that are potentially applicable to potential utility exchange transactions in a first utility unit, the second utility units having a different value than the first utility units that;
the computing means further for:
selectively detecting that a mobile device has entered a geographic region;
reviewing the database to determine if data is to be gathered for the geographic region of the mobile device; and
if data is to be gathered, sending a request to the mobile device for the user to gather data regarding the geographic region that the mobile device has entered, the request including, at least, second utility units that are to be given to the user of the mobile device if the user gathers the requested data and transmits that data to the computing means.

10. The system of claim 9, wherein the computing means further for receiving from the user of the mobile device a desired compensation amount in second utility units in response to the mobile device receiving a request to gather data on a geographic region.

11. The system of claim 9, wherein the computer means further for:
sending a plurality of options of second utility units to the user of the mobile device that the user can receive for gathering the requested data; and
receiving data from the user indicating a selection of a specific option of second utility units.

12. The system of claim 9, wherein the computing means further includes geographic location means for determining if a mobile device has entered a geographic region based upon location information sent from the mobile device.

13. A method for incentivizing and tracking an action of a user of a remote mobile device, comprising the steps of:
selectively detecting, at at least one server, that a mobile device has entered a geographic region, the at least one server that is selectively accessible to remote mobile devices across a network, and including a database that stores, at least, a data set of geographic regions for which data is gatherable, and second utility units that are potentially applicable to potential utility exchange transactions in a first utility unit, the second utility units having a different value than the first utility units that are used in utility exchange transactions;
reviewing the database to determine if data is to be gathered for the geographic region of the mobile device; and
if data is to be gathered, sending a request to the mobile device for the user to gather data regarding the geographic region that the mobile device has entered, the request including, at least, second utility units that are to be given to the user of the mobile device if the user gathers the requested data and transmits that data to the server.

14. The method of claim 13, further comprising the steps of:
sending data from the mobile device to the at least one server regarding an intended purchase transaction in a first utility unit; and
further determining, at the at least one server, second utility units to apply within the requested purchase transaction if data is to be gathered for the geographic area of the mobile device.

15. The method of claim 13, further comprising sending a desired compensation amount in second utility units from the mobile device to the server upon the mobile device receiving a request to gather data on a geographic region.

16. The method of claim 13, further comprising the steps of:
sending a plurality of options of second utility units from the at least one server to the user of the mobile device that the user can receive for gathering the requested data; and
receiving data at the at least one server from the user indicating a selection of a specific option of second utility units.

17. The method of claim 13, wherein the database further includes a plurality of user accounts for second utility units, and further comprising the step of allocating second utility units to the account of the user upon receipt of the requested gathered data.

18. The method of claim 14, wherein, upon receipt of the requested gathered data at the at least one server, the further comprising applying second utility units within a requested purchase transaction by the user in first utility units.

19. The method of claim 13, further comprising the step of determining, at the at least one server, if the mobile device has entered a geographic region based upon location information sent from the mobile device.

20. The method of claim 13, further comprising the step of determining, at the at least one server, if the mobile device has entered a geographic region based upon the receipt of a purchase transaction request sent from the mobile device.
